(19) United States
(12) Patent Application Publication
(10) Pub. No.: US 2003/0068504 A1
(43) Pub. Date: Apr. 10, 2003

(54) Flame retardant optical circuit

(76) Inventor: Abner D. Joseph, Carmel, IN (US)

Correspondence Address: Daniel J. Santos, Esq., Thomas, Kayden, Horstemeyer & Risley, L.L.P., Suite 1750, 100 Galleria Parkway, Atlanta, GA, 30339, US

(21) Appl. No.: 09/974,308

(22) Filed: Oct. 9, 2001

(51) Int. Cl. B32B 9/04

(52) U.S. Cl. 428/447

(57) ABSTRACT

An energy carrying circuit board, primarily for use with optical circuits, has a substrate made of fire retardant material, upon one surface of which is affixed a pressure sensitive adhesive layer. The adhesive layer is fire retardant and is a composition fabricated with the polymerization of acrylic esters. The energy carrying devices, e.g., optical fibers are affixed to one surface of the adhesive layer, and encapsulated by a fire retardant conformal coating of a silicone based material such as a silicone resin solution.

### RELATED PATENTS

The present application is related to U.S. Pat. Nos. 5,259,051; 5,582,673; 5,981,064; and 6,114,426, all of Burack et al., the disclosures of which are incorporated herein by reference.

### FIELD OF THE INVENTION

This invention relates to energy carrying devices such as substrate mounted optical circuits and, more particularly to such circuits having a high degree of flame retardancy.

### BACKGROUND OF THE INVENTION

It is common practice in the optical energy transmission art to form useful circuit components such as circuit boards and backplanes, for example, by mounting optical fibers, usually in a particular pattern, on a substrate which may be stiff or flexible but which, in the interest of versatility and ease of use, is preferably flexible. The substrate is typically formed of a flexible plastic material which, advantageously, is a polymer of the type commercially available as KAPTON™, which is flexible and, even more importantly, is non-flammable and does not melt. The fibers are mounted on the substrate in their desired pattern by means of a pressure-sensitive adhesive material and then are encapsulated, usually by a sheet of thermoplastic material as a protective cover, and to hold the fibers firmly in place.

A great deal of effort has been expanded in searching for optimum materials which not only are effective in the fabrication of the foregoing structure, but which exhibit a high degree of flame retardancy without detriment to the other desirable physical properties of the materials.

For example, the development of pressure-sensitive adhesives (PSA) that have good adhesive properties and yet are non-flammable and suitable for use in fiber optic and other energy-carrying devices has presented many challenges. A pressure-sensitive adhesive may be defined as a material that bonds surfaces at room temperature and with the application of some (and preferably a low) pressure. Typically, materials with good adhesive, cohesive, and tack qualities are also flammable. Pressure-sensitive materials based on acrylates or polyacrylates, for example, are tough, resilient, and flexible materials that have excellent pressure-sensitive adhesive properties, but they are also flammable.

To reduce the flammability of a pressure-sensitive adhesive, combustion-inhibiting compounds generally have been added to the adhesive. The most commonly-used additive is antimony trioxide which often is used in combination with halides, such as titanium tetrachloride. Making an adhesive flame retardant can be more complicated, however, than simply adding the combustion-inhibiting material, because the additive may disrupt the sensitive balance of properties of the material. For example, certain phosphates, while combustion-inhibiting, will greatly weaken the cohesive properties of the adhesives and cannot effectively be used.

The use of combustion-inhibiting additives has been found to be impractical for optical circuits. For the circuits to meet desired levels of flame retardancy as previously discussed, quantities of combustion-inhibiting additives at greater than twenty-five percent of the total solids would have to be added to the adhesive. However, typical flame retardant systems such as those based upon antimony oxide tend to settle out of acrylic coatings and adhesives, and they opacify the polymer and detract from its adhesive properties. Thus, the addition of sufficient quantities of combustion-inhibiting additives to meet flame-retardancy standards decreases the tack of the adhesive to the point that it can no longer meet desired fiber placement tolerances. The related U.S. Pat. Nos. 5,981,064 and 6,114,426 of Burack et al. deal with the foregoing PSA requirements, especially regarding flame retardancy and include PSA formulations that overcome the discussed problems, these in addition to numerous other solutions to the problems.

The Burack et al. U.S. Pat. Nos. 5,259,051 and 5,582,673 disclose encapsulates made from a variety of differing materials applied in sheets, such as thermoplastic materials, nylon, polypropylene, doped Mylar™, Kapton™, or even aluminum foil, with the sheet of material being pressed against the fibers, to encapsulate them, and the substrate (or the PSA). These materials, in most cases, do not meet the flammability specifications for many of the various applications utilizing the subject circuitry.

Thermoplastic material, by its nature, flows when heated, which may affect the structural integrity of the optical backplane. More importantly, when it flows in response, for example, to a flame it exposes the underlying adhesive to the air, which could cause the adhesive to ignite. Present flammability requirements could be met if the encapsulant were of a material capable of withstanding a flame and a heat of two hundred degrees Centigrade without igniting or losing its structural integrity.

The above-described references describe the need for an encapsulant that stabilizes the ends of the optical fibers with great precision, and yet does not exert such a force on the fibers to break them, particularly at “crossover” locations, that is, locations at which one fiber overlaps one or more other fibers. There is therefore a continuing need for an encapsulant that will meet these requirements and yet will not be significantly structurally affected by temperatures of at least two hundred degrees Centigrade.

There is also a simultaneous need for a pressure-sensitive adhesive that meets the desired flame retardation requirements while maintaining its adhesive qualities to a degree sufficient for the intended device applications.

There are several combinations of materials for the uses specified that yield a measurable, and in some cases, excellent, flame retardant characteristic, as measured by the Underwriters Laboratory (UL) 94 standards. These standards are well known, see, for example, “Standards, Bans, and Flame Retardants” by M. Robert Christy, Plastic Compounding (September/October 1993) at pp. 59-61. The UL 94 and UL 94VTM (for thinner materials) standards have been applied to optical circuit devices, with UL 940 or UL 94VTMO being the highest rating, the diminishing order of flame retardancy being UL94V1, UL94V2, etc. The art has achieved UL94V1 with some regularity, but UL 94V0 remains a more desirable rating that has, thus far, not been attainable on a production basis.

### SUMMARY OF THE INVENTION

The present invention comprises a flame retardant circuit, the structure of which overcomes to a large extent the disadvantages of prior art circuits as discussed in the foregoing and which, on the basis of UL94V tests, falls in the highest flame retardant class, UL94V0 and/or UL94VTMO. The present disclosure is directed towards optical circuitry, although it is to be understood that the basic structure of the invention is applicable to, for example, electronic circuitry as well.

In a preferred embodiment of the invention, a flexible substrate comprising a highly flame retardant material, such as, for example, a polymetric material such as KAPTON™ which is non-flammable and does not melt, has applied on one surface thereof an acrylic based transfer tape having a high degree of flame retardancy. The Burack et al. U.S. Pat. No. 6,114,426 discloses a pressure-sensitive, flame-retardant adhesive which comprises a composition fabricated with the polymerization of acrylic esters, debromostyrene and vinyl phosphonics acid, with or without acrylic acid, mixed with dispersions of antimony trioxide. This PSA has been found to work well with the present invention in producing a UL 94V0 rating. A similar PSA, commercially available from the 3M Corporation as Series 300FR, has also been found to work well. Affixed to the top surface of the adhesive layer are the optical fibers in whatever pattern is called for. The adhesive fixes and maintains the fibers in position on the supporting substrate.

A flame retardant conformal coating overlies the optical fibers to protect them and to maintain them in their desired orientation. The coating, in the preferred embodiment, is a flame retardant silicone based material, a silicone resin solution, containing octamethyltrisiloxane, demethyl methylhenylmethoxy siloxane, toluene, and methyltrimethoxysilane. The material, which is in its liquid form as supplied, is applied to the substrate fiber assembly by spraying, dipping, brushing, or flow coating, and cured with time. Final cure is typically achieved in seventy-two hours. The liquid thus applied conforms to the upper surface of the substrate—adhesive—fiber assembly, completely protectively covering the fibers and filling all interstices. After cure, the material of the coating has an operable temperature range of −65° C. to more than +200° C., thus yielding a high flame retardancy.

There are similar conformal coating materials that are commercially available from Dow Corning and Electra Polymers and Chemicals Ltd. and that are, at least to some extent, fire retardants.

The structure of the invention with any one of the PSAs mentioned and with one of the conformal coatings, or equivalents thereof, consistently yields a flexible optical circuit having a UL94V0 flammability rating, the maximum achievable under UL ratings.

The various features of the present invention will be more readily understood from the following detailed description, read in conjunction with the accompanying drawings.

### DESCRIPTION OF THE DRAWINGS

FIG. 1 is an elevation view, in cross-section, of a first stage in the fabrication of the optical circuit of the invention;

FIG. 2 depicts a second stage in the fabrications; and

FIG. 3 depicts the completed circuit of the invention.

### DETAILED DESCRIPTION

As was pointed out in the foregoing, it is a principal desideratum of optical circuit board arrangements that they have a high degree of flame retardance. Manufacturing techniques and materials have made it fairly common place to achieve an Underwriters Laboratory, Inc. flame retardant rating of UL94V1 in board production, but this is not the highest rating for such boards, i.e., UL94V0, or UL94VM0 for smaller or miniature boards. Such a rating has not been successfully achieved on a production basis for circuit boards.

In accordance with the Underwriters Laboratories, Inc. (UL) Standards for Safety UL94 Tests for Flammability of Plastic Materials for Parts In Duries and Appliances, Third Edition, for a vertical burn test for classifying materials as 94V-0, 94V-1, or 94V-2. For a UL94V1 classification, the materials shall meet the following criteria:

(A) The specimen shall not burn with flame combustion for more than thirty (30) seconds after application of the test flame;

(B) Shall not have a total flaming combustion time exceeding two hundred and fifty (250) seconds for ten (10) flame applications for each set of five specimens;

(C) Shall not have any specimen that burns with flaming or glowing combustion up to the holding clamp;

(D) Shall not have any specimens that drip flaming particles that ignite the dry surgical cotton located twelve (12) inches below the test specimen; and

(E) Shall not have any specimens with flowing combustion that persists for more than sixty (60) seconds after removal of the test flame.

On the other hand, for a material to be rated UL94V-0, the material shall not:

(A) Have any specimen that burns with flaming combustion for more than ten (10) seconds after application of the test flame;

(B) Have a total flaming combustion time exceeding fifty (50) seconds for the ten (10) flame applications for each set of five specimens;

(C) Have any specimens that burn with flaming or flowing combustion up to the holding clamps;

(D) Have any specimens that drip flaming particles that ignite the dry absorbent surgical cotton located twelve (12) inches below the test specimen; and

(E) Have any specimens with flowing combustion that persists for more than thirty (30) seconds after the second removal of the test flame.

From the foregoing, it can be seen that the flame retardant properties for a UL94V-0 rating are much more stringent than those for a UL94V-1 rating. The present invention, as depicted in the figures and described hereinafter, has consistently achieved a performance (flame retardancy) rating of UL94V-0 as set forth in the foregoing, though a unique combination of materials.

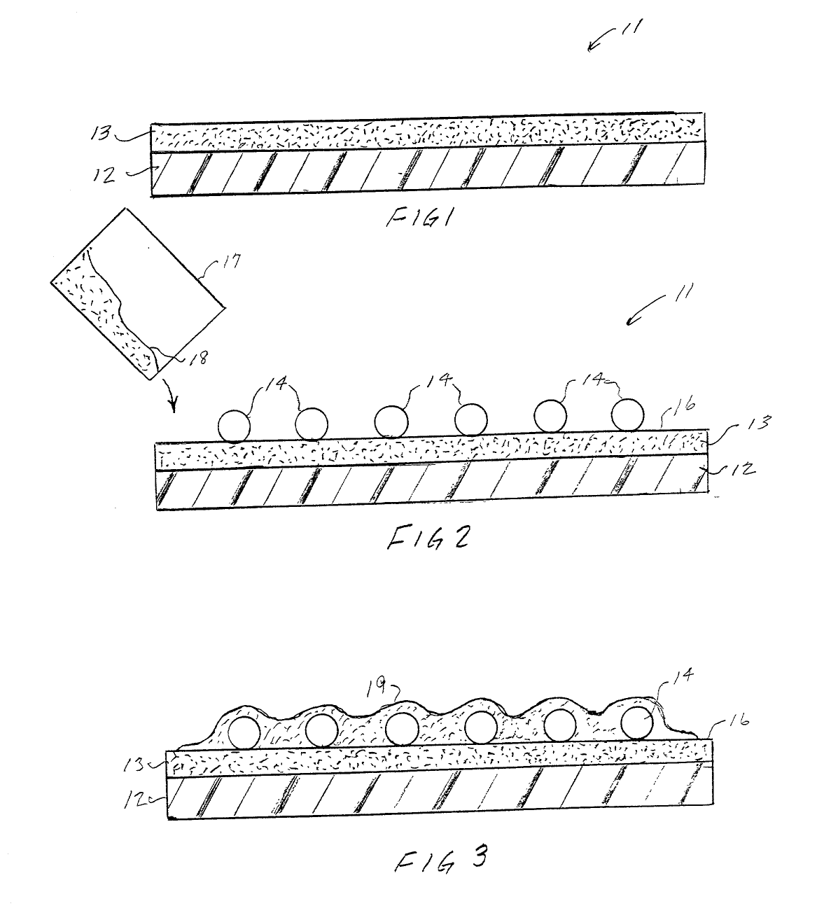

FIG. 1 depicts a first stage in the assembly of the circuit board 11 of the invention. Board 11 comprises a substrate 12 which is flexible (preferred), or rigid plastic advantageously fabricated from a polymer of the type commercially available as KAPTON™, which is non-flammable and which does not melt, even under extremes of heat. It is to be understood that other flame retardant or non-flammable materials may also be used, however, KAPTON™ is generally to be preferred. Overlying substrate 12 and affixed thereto is a pressure sensitive layer 13 of a tackified acrylic material that is flame retardant. Such a material is disclosed in the aforementioned U.S. Pat. No. 5,981,064 and comprises an acrylic adhesive material in which flame retardancy is imparted by the incorporation into the polymer backbone thereof. Preferably, the adhesive comprises a composition fabricated with a solution of emulsion polymerization of one or more acrylic esters, dibromostyrene, and vinyl phosponic acid, with or without acrylic acid, compounded with antimony trioxide. The high bromine content of the dibromostyrene provides good flame retardant properties while the aromaticity of the compound assures good thermal and hydrolytic stability. The phosphorous content of this adhesive increases the efficacy of the flame retardant to the point where only small quantities of Sb₂O₃ are needed to obtain the desired result, such that the adhesive tack of the composition is maintained at a level suitable for use in optical circuits. Preferred acrylic esters are butyl acrylate and 2-ethylhexyl acrylate, although other acrylates and/or methacrylates may be used such as, for example, methyl acrylate, methyl methacrylate, ethyl acrylate, hexyl acrylate, isoctyl acrylate, and vinyl acrylate, to name a few.

FIG. 2 depicts a second stage in the fabrication of the completed optical fiber board, such as a back plane, in which one or more optical fibers 14 are laid down on the upper surface 16 of the pressure sensitive adhesive layer 13 in whatever pattern is desired for the particular component being fabricated. U.S. Pat. No. 5,259,051 of Burack et al. illustrates a method and apparatus for depositing the optical fibers 14 in the desired pattern, and further illustrates several patterns of fibers 12 on the PSA layer. The fibers are applied to the layer 13 and adhere thereto, thus maintaining the desired pattern. FIG. 2 further shows a container 17, containing, in liquid form, a flame retardant conformal coating material 18 about to be poured over the fibers 12 and the surface 16 to produce the finished product 11 as shown in FIG. 3 which, after curing, which has a conformal coating 19 of material 18, as shown. Coating 18 may be poured sprayed or brushed onto the device 11, or device 11 may be dipped in the liquid material 18. The finished coating 19 completely covers the fibers 14, filling any and all interstices, and extends close to the edge of surface 16 to insure complete conformal coating of the fibers 14 and substantially complete coverage of surface 16. Thus, the fibers are substantially completely protected from external physical forces.

The material 18 is a flame retardant silicone based material, a silicone resin solution, comprising, in approximate percentages by weight: octamethyltrisiloxane (63); dimethyl methylphenylmethoxy siloxane (30); tuluene (3); and methyltrimethoxysilane (3) which is a highly flame retardant material. Similar fire retardant materials are commercially available from Dow Corning and from Electra Polymers and Chemicals, Ltd. It has been found that a conformal material having basically the formulation given is excellent for the purposes set forth hereinbefore.

The conformal coating 19 is cured with time, with final cure being in approximately seventy-two (72) hours. After cure, the material of the coating has an operable temperature range of −65° C. to more than +200° C. In conjunction with the flame retardant pressure sensitive adhesive 13, both of which individually are rated as Ul94V0, the finished assembly has been shown to have a rating of UL94V0 during the Underwriters Laboratories, Inc. tests.

It is to be understood that the various features of the present invention might be incorporated into other types of circuit boards, for example, and that other modifications or adaptations might occur to workers in the art. All such variations and modifications are intended to be included herein as being within the scope of the present invention as set forth. Further, in the claims hereinafter, the corresponding structures, materials, acts, and equivalents of all means or step-plus-function elements are intended to include any structure, material, or acts for performing the functions in combination with other elements as specifically claimed.

1. An energy carrying device comprising:
a substrate member made of a flame retardant material and having first and second surfaces;
a layer of flame retardant pressure sensitive adhesive mounted on said first surface and affixed thereto, said layer having a mounting surface remote from said first surface;
at least one energy carrying member mounted on said mounting surface and fixed in position thereby; and
a conformal coating of flame retardant material overlying and encapsulating said energy carrying member and at least a portion of said mounting surface.

2. An energy carrying device as claimed in claim 1 wherein the flame retardant material of said substrate is a polymetric material, and said pressure sensitive adhesive is composed of a flame retardant acrylic material.

3. An energy carrying device as claimed in claim 2 wherein said pressure sensitive adhesive material is a composition fabricated with the polymerization of acrylic esters, debromostyrene and vinyl phosphonic acid.

4. An energy carrying device as claimed in claim 3 wherein the pressure sensitive adhesive material further includes acrytic acid mixed with dispersions of antimony trioxide.

5. An energy carrying device as claimed in claim 1 wherein said conformal coating material comprises a flame retardant silicone resin solution.

6. An energy carrying device as claimed in claim 5 wherein said solutions contains octamethyltrisiloxane.

7. An energy carrying device as claimed in claim 6 wherein said solution further includes dimethyl methyltrimethoxysilane.

8. An energy carrying device as claimed in claim 1 wherein said pressure sensitive adhesive material comprises an acrylic ester chosen from the group cosnistign of butyl acrylate, 2-ethylhexyl acrylate, methyl acrylate,, methyl methacrylate, ethyl acrylate, hexyl acrylate, isoctyl acrylate, and vinyl acrylate.

9. An energy carrying device comprising:
a substrate member made of a flame retardant polymetric material and having first and second surfaces;
a layer of flame retardant pressure sensitive adhesive mounted on said first surface, said adhesive being composed of a flame retardant acrylic material, said layer having a mounting surface remote from said first surface;
at least one energy carrying member mounted on said mounting surface and fixed in position thereby; and
a conformal coating of flame retardant material overlying and encapsulating said energy carrying member and at least a portion of said mounting surface, said material comprising a silicone resin solution containing octamethyltrisiloxane, demethyl methylhenylmethoxy siloxane, toluene, and methyltrimethoxysilane.

10. An energy carrying device as claimed in claim 9 wherein the material of said pressure sensitive adhesive further comprises debromostyrene and vinyl phosphonic acid, and acrylic acid mixed with dispersions of antimony trioxide.

11. An energy carrying device as claimed in claim 9 wherein said conformal coating comprises, in a silicon solution in approximate percentages by weight:
octamethyltrisiloxane (63%);
dimethyl methylphenylmethoxy siloxane (37%); and
methyltrimethyloxysilane (3%).
